(19) United States
(12) Patent Application Publication
(10) Pub. No.: US 2015/0356574 A1
(43) Pub. Date: Dec. 10, 2015

(54) SYSTEM AND METHOD FOR GENERATING DESCRIPTIVE MEASURES THAT ASSESSES THE FINANCIAL HEALTH OF A BUSINESS

(71) Applicant: THE DUN & BRADSTREET CORPORATION, Short Hills, NJ (US)

(72) Inventors: Paul Douglas BALLEW, Madison, NJ (US); Alla KRAMSKAIA, Edison, NJ (US); Joan KELLEHER, Bernardsville, NJ (US); Robin DAVIES, Macungie, PA (US); Kevin F. CONLEY, Bethlehem, PA (US)

(21) Appl. No.: 14/734,842

(22) Filed: Jun. 9, 2015

Related U.S. Application Data
(60) Provisional application No. 62/009,698, filed on Jun. 9, 2014.

(51) Int. Cl. G06Q 30/02; G06Q 40/00

(52) U.S. Cl. CPC G06Q 30/0201; G06Q 40/00

(57) ABSTRACT

A system and a method for generating indicators of the financial health of a business provides data in a number of cases, including a situation where financial statement are publically available, and those where they are not publically available. Data records are analyzed in accordance with a first set of steps if publically available financial statements of the business are available; and in accordance with a second set of steps if publically available financial statements of the business are not available. When financial statements are not publically available, certain proxies provide data concerning a business. A computer readable non-transitory storage medium stores instructions of a computer program, which when executed by a computer system, results in performance of steps of the method. A method for developing a scorecard for data indicative of the financial health of a business is also disclosed.

### CROSS-REFERENCED APPLICATION

This application claims priority to U.S. Provisional Application No. 62/009,698, filed on Jun. 9, 2014, which is incorporated herein in its' entirety by reference thereto.

### BACKGROUND

1. Field of the Disclosure

The present disclosure relates to the evaluation of businesses. More particularly it relates to a system and a method for ascertaining the health of a business, and ascertaining the health of a business when there is limited publically available information.

2. Description of the Related Art

The ability to evaluate the financial status of a business and distill the information into insights about current risks and opportunities associated with that business is critical to establishing and managing existing relationships with businesses. Risk and opportunity are two such dimensions, but others need to be included. To aid in the evaluation, many rely upon traditional public and private sector financial documents. However, these documents are not always made available publically. When financial documents are not available, other intelligence is used that does not always reflect the financial standing of a company. Such information may not in itself be actionable in representing the financial status of a business entity.

There is a need for a system and a method for generating descriptive indicators of the health of a business when financial statements are readily available or when financial statements are not available.

### SUMMARY

An evaluation of an entity's financial statement is often one of the key components when making credit decisions for that entity. However, when an entity withholds financial statements, for a variety of reasons including confidentiality, competitive reasons or to avoid sharing negative results publically, having an alternative measure to evaluate financial statement elements can determine if an entity is encountering financial stress or growth. Combined with other signals impacting the entity, the system and the method can yield insight that it is approaching either a deterioration or improvement stage when it comes to credit risk. The insight generated could be used by another entity for credit or partnership decisions, as examples.

When evaluating the financial health of particular industries, a variety of measures are often harnessed to make a holistic evaluation. Often, the number of businesses with published financial statements within an industry segment is too small to evaluate the financial health of the industry. The system and method disclosed herein generate a more encompassing review of the overall universe, allowing results to be examined in aggregate and segmented by industries, providing another barometer to evaluate the financial health of individual sectors. A more comprehensive view is produced by not only evaluating businesses that have shared financial statements, but by harnessing proxies that are more readily available on a vast majority of the credit active universe, projected to be up to 90% of this audience. This greater coverage permits results to be evaluated within specific sectors. This barometer of the financial health of entities focuses more on the financial elements vs. conventional financial stress classifications that provide an evaluation of business failure, answering the question: Will the entity ever pay vs. determining the ability of the entity to pay.

The system and method disclosed herein are based on a large sampling of traditional financial statements, segmented by both public and private entities, in order to determine the financial elements that carry the most relevant value. Through advanced analysis, proxies were determined for the most important financial elements. The proxies are more readily available when it comes to the overall business universe.

Financial proxies can be variables that describe financial behavior and/or financial health, and have a strong correlation with the viability or failure of an entity. A proxy is not the actual financial data, but correlates with key financial figures such as assets, liabilities or sales. To determine if a potential proxy source represents a proxy of financial data it must be predictive of actual financial data, it must be tested in a univariate mode against failure/viability performances, and it must be tested in combination with other proxies against failure/viability performances.

Examples of financial proxies include store openings and closings, announced mergers and acquisitions, labor and hiring data, etc. When traditional financial documents are not available, the proxies are evaluated by a model to assess the current financial health of a company. Since the vast majority of businesses do not publish financial statements, the model ultimately provides a more comprehensive evaluation of the financial status of the greater business community at large.

Thus an embodiment of the disclosure is directed to a system.

A further embodiment of the disclosure is directed to a method.

Yet another embodiment of the disclosure is directed to a computer readable non-transitory storage medium storing instructions of a computer program which when executed by a computer system results in performance of steps of the method.

### BRIEF DESCRIPTION OF THE DRAWINGS

FIG. 1 is a detailed flow chart of the disclosed method.

FIG. 2 is a high level conceptual flow chart of a model development process used for developing the disclosed embodiments.

FIG. 3 is a spreadsheet of data for three businesses, the data for each business being analyzed in accordance with one of three different paths in the flow chart of FIG. 1.

FIG. 4 is an illustration of a computer system used to implement the disclosed embodiment.

A component or a feature that is common to more than one drawing is indicated with the same reference number in each of the drawings.

### DESCRIPTION OF THE PREFERRED EMBODIMENTS

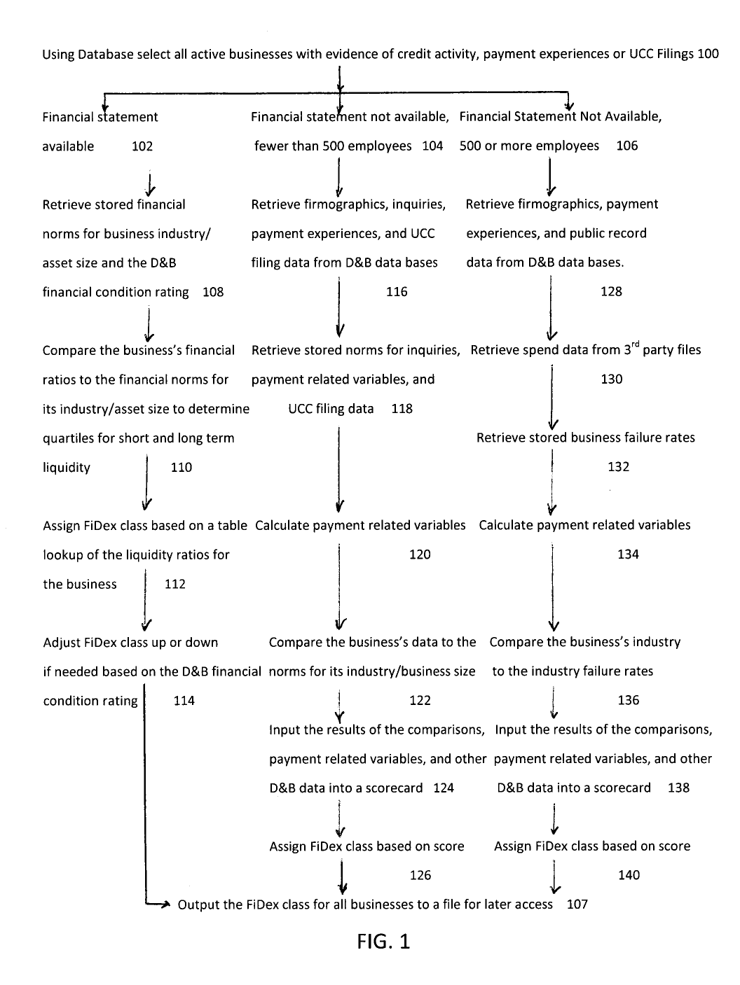

FIG. 1 is a flow chart of an embodiment of the method disclosed herein. At 100, using a database, all active businesses with evidence of credit activity, payment experiences or UCC filings, are selected. It is preferred that the database be the Dun & Bradstreet, Inc. database containing data on millions of companies. However, other databases containing similar information can be used.

After the data is selected, an analysis of a particular company can take one of three paths. At 102, a first path is selected if financial statements concerning the company of interest are available. At 104, a second path is selected when financial statements are not available and the business has fewer than 500 employees. At 106, a third path is selected when financial statements are not available but the business has 500 or more employees. At 107, the so called FiDex class for all businesses is stored to a file for later access, regardless of the path utilized to compute the FiDex class.

The FiDex class is represented by a scale of 1 to 9, with a one being the best possible score and a 9 being the poorest score. Thus, the FiDex class describes the current state of a business's financial health in the presence or absence of financial statements. Financial health is based on the short-term (quick ratio) and overall (total assets to total liabilities) liquidity. The quick ratio is defined as (total current assets−inventory)/total current liabilities. The quick ratio is a measure of short term (1 year) liquidity that does not depend on selling inventory.

A FiDex class of 1 represents a company that has strong financial health consistent with on-time payments and stable money management. A FiDex class of 9 represents a company that has poor financial health consistent with a high debt-to-revenue ratio and late payments. The FiDex class is a descriptive measure relative to other businesses within the same industry. When financial data is available, the FiDex class leverages balance sheet ratios to determine the current financial standing. When financial data is not available, the FiDex class utilizes non-financial characteristics that are a proxy for financial health.

When the first path is followed, at 108, stored financial norms for the business by industry/asset size, financial ratios for the business, and the financial condition rating for the business, are retrieved from the database. At 110, the financial ratios of the business are compared to the financial norms for its industry/asset size to determine quartiles for short and long term liquidity. The financial ratios used are quick ratio and total liabilities to total assets. Current Ratio is substituted for quick ratio if quick ratio is not available or known. Current ratio is defined as total current liabilities to total current assets. The financial norms are values for the 25^{th} percentile, median, and 75^{th} percentile calculated from a representative group of financial statements for the industry and asset size. The ratio quartiles are determined by comparing the ratios for the business to the norms. If the ratio for the business is in the best 25% for its normative group, the quartile for the business is 1. The next best 25% is quartile 2, etc. Based on the quartiles for the two ratios used, judgment is applied to assign a FiDex class as shown at 112.

At 112, an initial FiDex class is assigned to the business based on a table lookup of the liquidity ratios for the business. An example is Table I below.

TABLE I

| | Total Liabilities to | |
|---|---|---|
| Quick (Current) | Net Worth | FiDex |
| Ratio Quartile | Ratio Quartile | Class |
| 1 | 1 | 1 |
| 1 | 2 | 2 |
| 2 | 1 | 2 |
| 2 | 2 | 3 |
| 1 | 3 | 3 |
| 3 | 1 | 3 |
| 2 | 3 | 4 |
| 3 | 2 | 4 |
| 3 | 3 | 5 |
| 1 | 4 | 6 |
| 4 | 1 | 6 |
| 2 | 4 | 7 |
| 4 | 2 | 7 |
| 3 | 4 | 8 |
| 4 | 3 | 8 |
| 4 | 4 | 9 |

Other measures of financial health for businesses that have financial statements may be available. The D&B financial condition rating is one such measure.

At 114, the FiDex class is adjusted up or down, as needed, based on the financial condition rating. This is done by using Table II below.

TABLE II

| Fidex Class | Financial condition | Adjusted Class |
|---|---|---|
| 1 | T | 1 |
| 1 | U | 1 |
| 1 | V | 2 |
| 1 | W | 4 |
| 2 | T | 2 |
| 2 | U | 2 |
| 2 | V | 3 |
| 2 | W | 4 |
| 3 | T | 3 |
| 3 | U | 3 |
| 3 | V | 4 |
| 3 | W | 5 |
| 4 | T | 3 |
| 4 | U | 4 |
| 4 | V | 4 |
| 4 | W | 5 |
| 5 | T | 4 |
| 5 | U | 4 |
| 5 | V | 5 |
| 5 | W | 6 |
| 6 | T | 4 |
| 6 | U | 5 |
| 6 | V | 6 |
| 6 | W | 7 |
| 7 | T | 5 |
| 7 | U | 6 |
| 7 | V | 7 |
| 7 | W | 7 |
| 8 | T | 6 |
| 8 | U | 6 |
| 8 | V | 8 |
| 8 | W | 8 |
| 9 | T | 6 |
| 9 | U | 6 |
| 9 | V | 9 |
| 9 | W | 9 |

The assignment of the Fidex class may be made based on a calculation, as described below, and by using one of the tables for Model 1 or Model 2 below. Models 1 and 2 are scorecard models based on logistic regression to separate businesses with the best financial health from those with the worst financial health. A scorecard model is a method of transforming the equation that is the output of a logistic regression model into an algorithm that is based on the accumulation of points. Scorecard models are directly derived from the equation that is the output of the logistic regression model. Every business starts out with a base score. Points are accumulated towards a final score based on the characteristics, and presence or absence, of relevant data. Rather than multiply the input data elements by a coefficient, a number of points is assigned to the value of the data element. The points assigned can be determined from a statistical product such as, for example, SAS Enterprise miner. Other analysis approaches can also be used.

At 107, the FiDex class is stored.

### Model 1

| Minimum | Maximum | FiDex |
|---|---|---|
| Score | Score | Class |
| 415 | 999 | 1 |
| 391 | 414 | 2 |
| 369 | 390 | 3 |
| 349 | 368 | 4 |
| 331 | 348 | 5 |
| 272 | 330 | 6 |
| 229 | 271 | 7 |
| 167 | 228 | 8 |
| 101 | 166 | 9 |

### Model 2

| Minimum | Maximum | FiDex |
|---|---|---|
| Score | Score | Class |
| 476 | 999 | 1 |
| 428 | 475 | 2 |
| 398 | 427 | 3 |
| 349 | 397 | 4 |
| 318 | 348 | 5 |
| 273 | 317 | 6 |
| 252 | 272 | 7 |
| 238 | 251 | 8 |
| 101 | 237 | 9 |

When the second path is followed, at 116, firmographics, inquiries, payment experiences, and UCC filing data are retrieved from the database. At 118, stored norms for inquiries, payment related variables, and UCC filing data are retrieved. At 120, payment related variables are calculated. Payment related variables are derived from payment experience data, such as the percentage of slow trade out of all trade and the statistical variance in payment patterns.

Continuing in FIG. 1, at 122, the data of the business of interest is compared to the norms for its industry and business size. Norms may include the mean number of UCC filings and the mean number of credit inquiries, as well as means for other data elements that may relate to debt level. The comparison is done by calculating the difference from the mean of the business's value for the data element from the industry/business size group mean for the data element. At 124, the results of the comparisons, payment related variables, and other data are used as input to a first scorecard, wherein points are accumulated based on the data associated with the businesses, to calculate a FiDex score for businesses without a financial statement and with fewer than 500 employees. The scorecard can have as inputs the statistical variance in the D&B PayDex® score for a given period of time (for example, 12 months), an adjustment amount representing difference from the mean for the industry/business size group of total amount of payment experiences past due, difference from the mean for the industry/business size group of average high credit from trade and the norms or mean, difference from the mean for the industry/business size group of average high credit from a case study and norms, difference from the mean for the industry/business size group of the number of UCC filings from norms, the percentage of accounts past due for a given period of time (for example, 4 months), the number of satisfactory payment experiences and total payment experiences from trade, and a constant related to the particular industry, based on the SIC code.

At 126, a FiDex class is assigned based on the FiDex score. At 107, the FiDex class is stored.

When the third path is followed, at 128, firmographics, payment experiences, and public record data from the database is retrieved. At 130, spend data from third party files (generally, these proprietary files are files that cannot be resold, but are licensed for use in scoring) is retrieved. At 132 stored business failure rates is retrieved. At 134, payment related variables are calculated. Payment related variables are calculated variables derived from payment experience data, such as the percentage of slow trade out of all trade and the statistical variance in payment patterns.

At 136, the failure rates of the businesses are compared to the industry business failure rate. The failure rates for businesses are calculated by determining the percentage of businesses that fail (file for bankruptcy or go out of business leaving debt) over a one year time period. For comparison, it is determined whether or not the business being evaluated is in an industry that has the lowest failure rates (best 10%), the highest failure rates (worst 10%), or neither of these.

At 138, the results of the comparisons, payment related variables, and other D&B data are used as input to a second scorecard, wherein points are accumulated based on the data associated with the businesses, to calculate a FiDex score for businesses without a financial statement and with 500 or more employees. The second scorecard can have as inputs the dollar amount of open liens from public records, one or more constants related to the particular industry, based on the SIC code, the number of slow payment experiences, the number of write offs or placed for collection, the total number of payment experiences from trade, the number of years since the business was started, the average purchase amount per month in the last six months, the number of buyers in the last six months, whether the company has a bad history of previous bankruptcy or severe criminal activity, and the total amount of active accounts in a predetermined period of time (for example, the past three months).

The variables listed as inputs to the scorecards described herein are merely listed by way of example. Other business related variables that may be publically available can be used, and the weights or points assigned to the numerical value of each variable may differ, depending on the manner in which it is decided to implement the embodiments disclosed herein.

At 140, a FiDex class is assigned based on the FiDex score. At 107, the FiDex class is stored.

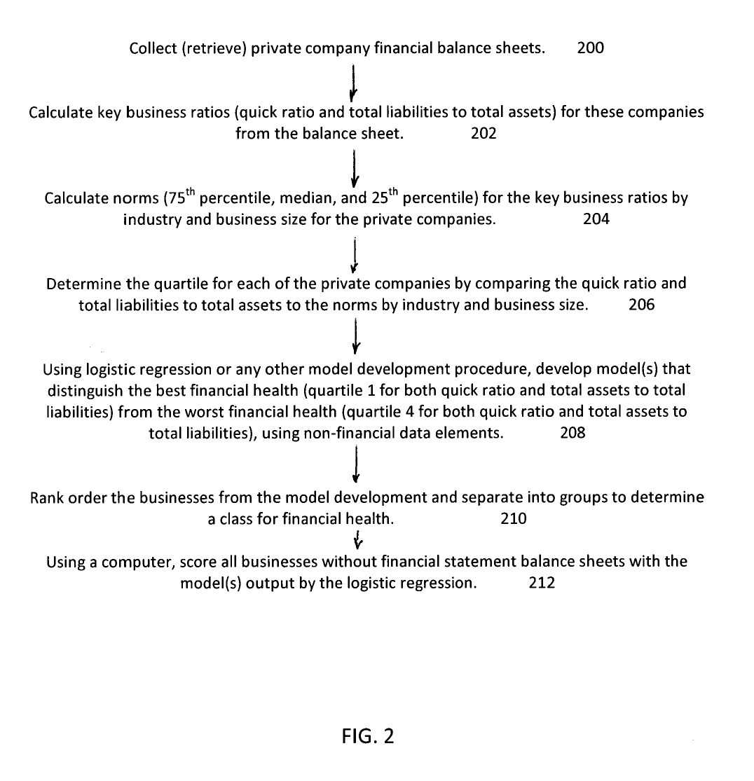

FIG. 2 is a flow chart of how method development in accordance with the invention can be conducted. Models 1 and 2, discussed above, can be developed by using the method development steps of FIG. 2. At 200, company financial balance sheets (generally private in nature) are collected or retrieved from a database. At 202 key business ratios (quick ratio and total liabilities to total assets) for these companies are calculated from balance sheets. At 204, norms (75^{th} percentile, median, and 25^{th} percentile) are calculated for the key business ratios by industry and business size for the private companies. At 206, the quartile for each of the companies is determined by comparing the quick ratio and total liabilities to total assets to the norms by industry and business size. At 208, a model or models are developed using logistic regression or any other model development procedure that distinguish the best financial health (quartile 1 for both quick ratio and total assets to total liabilities) from the worst financial health (quartile 4 for both quick ratio and total assets to total liabilities), using non-financial data elements. At 210, the businesses from the model development are rank ordered and separated into groups to determine a class for financial health. At 212, score all businesses without financial statement balance sheets with the model(s) output by the logistic regression.

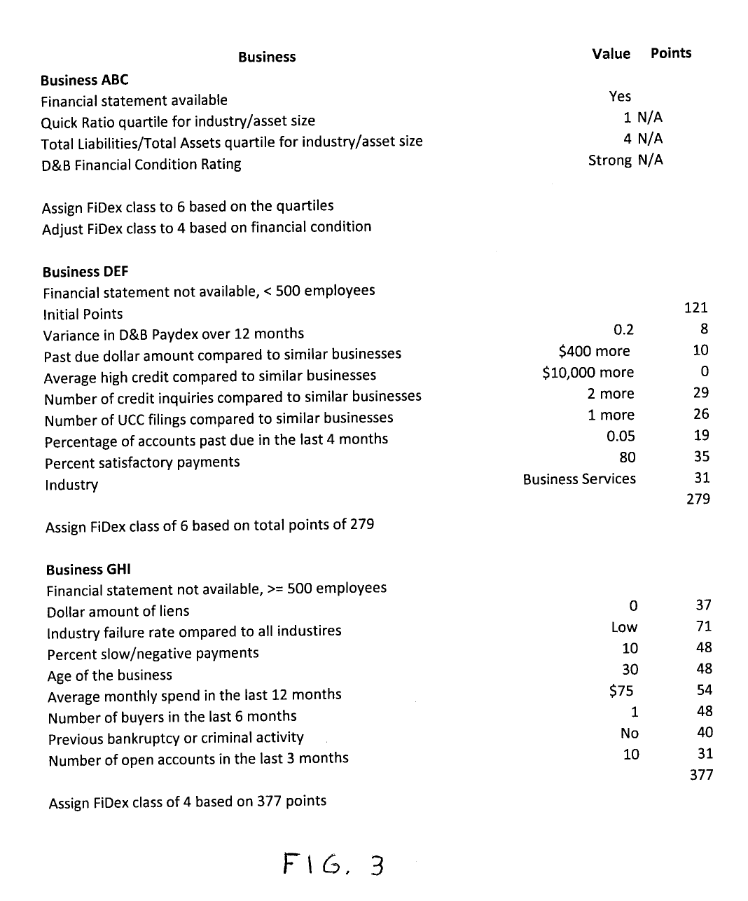

Referring to FIG. 3, a spreadsheet showing the derivation of the FiDex classes for three businesses is shown. Financial statements are available for business ABC, and the first path through FIG. 1 is followed. Financial statements are not available for business DEF, which has less than 500 employees, and the second path through FIG. 1 is followed. Financial statements are not available for business GHI, which has 500 or more employees, and the third path through FIG. 1 is followed. These assignments are based on the use of Model 2 above.

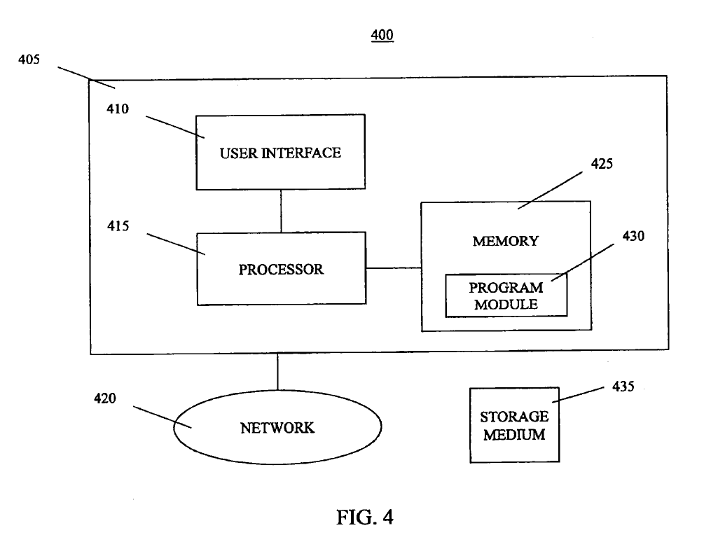

Referring to FIG. 4, system 400 for implement the embodiments disclosed herein includes a computer 405 coupled to a network 420, e.g., the Internet. Computer 405 includes a user interface 410, a processor 415, and a memory 425. Computer 405 may be implemented on a general-purpose microcomputer. Although computer 405 is represented herein as a stand-alone device, it is not limited to such, but instead can be coupled to other devices (not shown) via network 420. In implementing the system and method disclosed herein, in general, it is preferred that processing be automatically scheduled by a job scheduling system (not shown).

Processor 415 is configured with logic circuitry that responds to and executes instructions. Memory 425 stores data and instructions for controlling the operation of processor 415. Memory 425 may be implemented in a random access memory (RAM), a read only memory (ROM), or a combination thereof. One component of memory 425 is a program module 430. Program module 430 contains instructions for controlling processor 415 to execute the methods described herein.

The term “module” is used herein to denote a functional operation that may be embodied either as a stand-alone component or as an integrated configuration of a plurality of sub-ordinate components. Thus, program module 430 may be implemented as a single module or as a plurality of modules that operate in cooperation with one another. Moreover, although program module 430 is described herein as being installed in memory 425, and therefore being implemented in software, it could be implemented in any of hardware (e.g., electronic circuitry), firmware, software, or a combination thereof.

User interface 410 includes an input device, such as a keyboard or speech recognition subsystem, for enabling a user to communicate information and command selections to processor 415. User interface 410 also includes an output device such as a display or a printer. A cursor control such as a mouse, track-ball, or joy stick, allows the user to manipulate a cursor on the display for communicating additional information and command selections to processor 415. Processor 415 outputs, to user interface 410, a result of an execution of the methods described herein. Alternatively, processor 415 could direct the output to a remote device (not shown) via network 420.

While program module 430 is indicated as already loaded in memory 425, it may be configured on a storage medium 435 for subsequent loading into memory 425. Storage medium 435 can be any conventional storage medium that stores program module 430 thereon in tangible form. Examples of storage medium 435 include a floppy disk, a compact disk, a magnetic tape, a read only memory, an optical storage media, universal serial bus (USB) flash drive, a digital versatile disc, or a zip drive. Alternatively, storage medium 435 can be a random access memory, or other type of electronic storage, located on a remote storage system and coupled to computer 405 via network 420.

While a “database” is referred to herein, it will be understood that such database can refer to a single database or many databases from which the required data may be obtained or in which it is or can be stored.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system for generating indicators of the financial health of a business, comprising:
a processor;
a memory coupled to the processor and having stored instructions for causing the processor to perform steps including:
obtaining data records of a business;
determining whether there are publically available financial statements of the business;
analyzing the data records according to a first set of steps if publically available financial statements of the business are available; and
analyzing the data records according to a second set of steps if publically available financial statements of the business are not available, wherein the data includes proxies for the financial statements of the business.

2. The system of claim 1, wherein if publically available financial statements of the business are not available, the second set of steps includes a first series of steps if the number of employees of the business is less than a predetermined number, and the second set of steps includes a second series of steps if the number of employees of the business is equal to or greater than a predetermined number.

3. The system of claim 2, wherein the predetermined number of employees is 500 employees.

4. The system of claim 2, wherein the first series and the second series of steps each includes using a scorecard having as inputs a plurality of business health indicators.

5. The system of claim 4, wherein the scorecard is derived from an equation used for analysis that order ranks businesses in accordance with business health of the businesses.

6. The system of claim 5, wherein the analysis is a regression analysis.

7. The system of claim 1, wherein the first set of steps includes using a scorecard having as inputs data derived, at least in part, from the financial statements.

8. The system of claim 7, wherein the scorecard is derived from an equation used for analysis that order ranks businesses in accordance with business health of the businesses.

9. The system of claim 8, wherein the analysis is a regression analysis.

10. The system of claim 8, wherein the scorecard provides an initial number of points, and data in the data records adds points to arrive at a point value used to rank the health of the business.

11. A computer implemented method for generating indicators of the financial health of a business, comprising using a computer having a processor and a memory to perform steps of:
obtaining data records of a business;
determining whether there are publically available financial statements of the business;
analyzing the data records according to a first set of steps if publically available financial statements of the business are available; and
analyzing the data records according to a second set of steps if publically available financial statements of the business are not available, wherein the data includes proxies for the financial statements of the business.

12. The method of claim 11, wherein if publically available financial statements of the business are not available, the second set of steps includes a first series of steps if the number of employees of the business is less than a predetermined number, and the second set of steps includes a second series of steps if the number of employees of the business is equal to or greater than a predetermined number.

13. The method of claim 12, wherein the predetermined number of employees is 500 employees.

14. The method of claim 12, wherein the first series and the second series of steps each includes using a scorecard having as inputs a plurality of business health indicators.

15. The method of claim 14, further comprising deriving the scorecard from an equation used for analysis that order ranks businesses in accordance with business health of the businesses.

16. The method of claim 15, wherein the analysis is a regression analysis.

17. The method of claim 11, wherein the first set of steps includes using a scorecard having as inputs data derived, at least in part, from the financial statements.

18. The method of claim 17, further comprising deriving the scorecard from an equation used for analysis that order ranks businesses in accordance with business health of the businesses.

19. The method of claim 18, wherein the analysis is a regression analysis.

20. The method of claim 18, wherein the scorecard provides an initial number of points, and data in the data records adds points to arrive at a point value used to rank the health of the business.

21. A computer readable non-transitory storage medium storing instructions of a computer program which when executed by a computer system results in performance of steps of a method for, comprising:
obtaining data records of a business;
determining whether there are publically available financial statements of the business;
analyzing the data records according to a first set of steps if publically available financial statements of the business are available; and
analyzing the data records according to a second set of steps if publically available financial statements of the business are not available, wherein the data includes proxies for the financial statements of the business.

22. A method for developing a scorecard for data indicative of the financial health of a business, comprising:
collecting financial statement of a multitude of businesses;
calculating key business ratios for the businesses from the financial statements;
calculating norms for the key business ratios by industry and business size;
determine a quartile for each of the businesses by comparing a quick ratio and a ratio of total liabilities to total assets to the norms by industry and business size;
using a model development procedure, to develop at least one model that distinguish businesses in best financial health from businesses in worst financial health;
rank ordering the businesses from the model development;
separating the businesses into groups to determine a class for financial health; and
scoring all businesses without publically available financial statement with the at least one model provided by the logistic regression.
